(19) United States
(12) Patent Application Publication
(10) Pub. No.: US 2022/0371332 A1
(43) Pub. Date: Nov. 24, 2022

(54) APPARATUS HAVING RECIRCULATION CAVITIES

(71) Applicant: Hewlett-Packard Development Company, L.P., Spring, TX (US)

(72) Inventors: Lynn A. Collie, Vancouver, WA (US); Matthew Raisanen, Vancouver, WA (US); Robert Yraceburu, Vancouver, WA (US); Elliott Downing, Vancouver, WA (US)

(21) Appl. No.: 17/771,612

(22) PCT Filed: Nov. 1, 2019
(86) PCT No.: PCT/US19/59320

§ 371 Date: Apr. 25, 2022

(51) Int. Cl. B41J 2/18; B41J 2/175

(52) U.S. Cl. CPC B41J 2/18; B41J 2/17596; B41J 2202/12

(57) ABSTRACT

In some examples, an apparatus can include a valve body including a recirculation inlet path and a recirculation outlet path, a piston assembly located in the valve body, and a recirculation cavity between the valve body and the piston assembly, where print material is to be circulated through the recirculation cavity via the recirculation inlet path and the recirculation outlet path.

### BACKGROUND

Imaging systems, such as printers, copiers, etc., may be used to form markings on a physical medium, such as text, images, etc. In some examples, imaging systems may form markings on the physical medium by performing a print job. A print job can include forming markings such as text and/or images by transferring a print material (e.g., ink, toner, etc.) to the physical medium.

### BRIEF DESCRIPTION OF THE DRAWINGS

FIG. 1 is a section view of an example of an apparatus having recirculation cavities consistent with the disclosure.

FIG. 2 is a top section view of an example of an apparatus having recirculation cavities consistent with the disclosure.

FIG. 3 is a section view of an example of a valve having recirculation cavities consistent with the disclosure.

FIG. 4 is a perspective partially exploded view of an example of a system including a valve having recirculation cavities and a septum receptacle consistent with the disclosure.

FIG. 5 is a perspective partially exploded view of an example of a system including a valve having recirculation cavities and a septum receptacle consistent with the disclosure.

FIG. 6 is a perspective view of an example of a system including a valve having recirculation cavities, a septum receptacle, and a frame consistent with the disclosure.

FIG. 7 is a section view of an example of a valve having recirculation cavities consistent with the disclosure.

FIG. 8 is a section view of an example of a valve having recirculation cavities consistent with the disclosure.

FIG. 9 is a perspective view of an example of a septum receptacle consistent with the disclosure.

FIG. 10 is a perspective view of an example of a septum receptacle consistent with the disclosure.

### DETAILED DESCRIPTION

Imaging devices may include a supply of a print material located in a print material supply cartridge. As used herein, the term “print material” refers to a substance which can be transported through and/or utilized by an imaging device. In some examples, print material can be, for instance, a material that when applied to a medium, can form representation(s) (e.g., text, images models, etc.) on the medium during a print job. In some examples, print material can be, for instance, cleaning fluids, fluids for chemical analysis, fluids to be included during transportation of the imaging device (e.g., shipping to a customer), etc.

The print material can be deposited onto a physical medium. As used herein, the term “imaging device” refers to any hardware device with functionalities to physically produce representation(s) (e.g., text, images, models, etc.) on the medium. In some examples, a “medium” may include paper, photopolymers, plastics, composite, metal, wood, or the like.

The print material supply cartridge including the print material may interface with the imaging device and include a supply of the print material such that the print material may be drawn from the print material supply cartridge as the imaging device creates the images on the print medium. As used herein, the term “print material supply cartridge” refers to a container, a tank, and/or a similar vessel to store a supply of the print material for use by the imaging device. In some examples, the print material supply cartridge can provide print material directly to a print head of the imaging device. In some examples, the print material supply cartridge can supply print material to a print material reservoir which can provide print material to a print head of the imaging device.

As the print material is provided to the imaging device via the print material supply cartridge (e.g., directly to a print head or to a reservoir), the amount of print material in the print material supply cartridge may deplete. As a result, the amount of print material in a print material supply cartridge or a print material reservoir of the imaging device may have to be replenished.

A print material supply cartridge may be filled, replaced, etc. In some examples, the print material supply cartridge may supply print material to a reservoir and be removed. In some examples, the print material supply cartridge may be interfaced with the imaging device and reside in the imaging device to provide print material when appropriate. The valve system may include a valve that can be meant to be opened when the print material supply cartridge is attached to the imaging device.

In some instances, the valve may not be used for extended periods of time. For example, print material may be provided to a reservoir of an imaging device and may not be replenished for an extended period of time as the imaging device may include a large print material reservoir, the imaging device may not perform many print jobs, etc. In such an instance, the valve may not be exposed to print material for extended periods of time, which can result in print material drying out. This dried out print material can inhibit and/or prevent valve function, may be transported into the imaging device, etc., which may cause damage to the valve and/or imaging device.

An apparatus having recirculation cavities, according to the disclosure, can allow for print material to be provided to a cavity in the valve. Accordingly, providing print material to the cavity in the valve can allow for the valve to be wetted and provide print material to be recirculated in the cavity of the valve to prevent print material from drying in the valve.

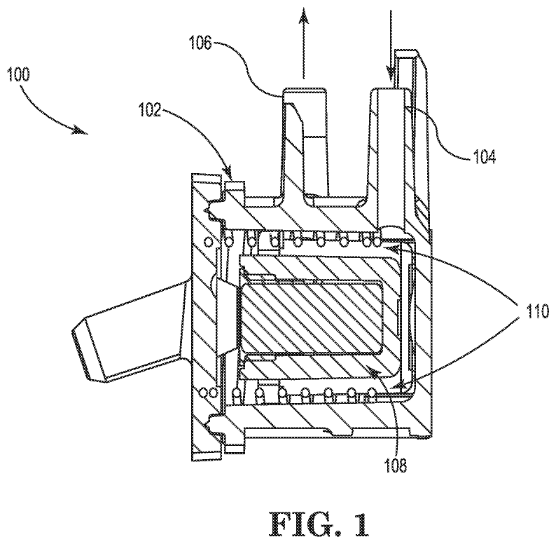

FIG. 1 is a section view of an example of an apparatus 100 having recirculation cavities consistent with the disclosure. The apparatus 100 can include a valve body 102, a recirculation inlet path 104, a recirculation outlet path 106, a piston assembly 108, and a recirculation cavity 110.

As illustrated in FIG. 1, the apparatus 100 can include a valve body 102, As used herein, the term “valve body” refers to a physical structure of a valve. As used herein, the term “valve” refers to a device that regulates the flow of a fluid by opening, closing, or partially obstructing a passageway. For example, the apparatus 100 can regulate the flow of print material through the apparatus 100 by actuating the piston assembly 108.

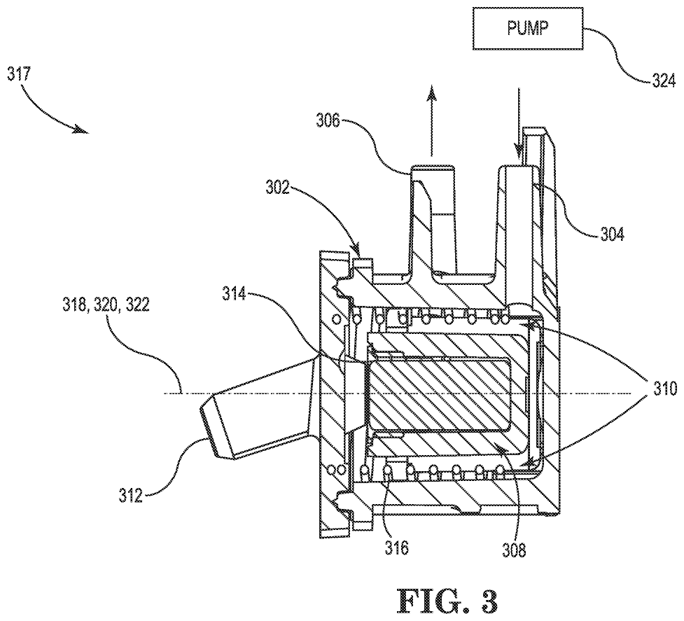

The piston assembly 108 can include a group of components. For example, the piston assembly 108 can include a piston, a magnet, and a piston seal (e.g., as is further described in connection with FIG. 3.

The valve body 102 can include a recirculation inlet path 104. As used herein, the term “recirculation path” refers to a passage along which something moves. For example, the recirculation inlet path 104 can be a passage along which print material moves into the valve body 102, as is further described herein. In some examples, the recirculation inlet path 104 can be a port. For example, the recirculation inlet path 104 can be an aperture through which print material can be provided to the valve body 102.

The valve body 102 can include a recirculation outlet path 106. For example, the recirculation outlet path 106 can be a passage along which print material moves out of the valve body 102, as is further described herein. In some examples, the recirculation outlet path 106 can be a port. For example, the recirculation outlet path 106 can be an aperture through which print material can exit from the valve body 102.

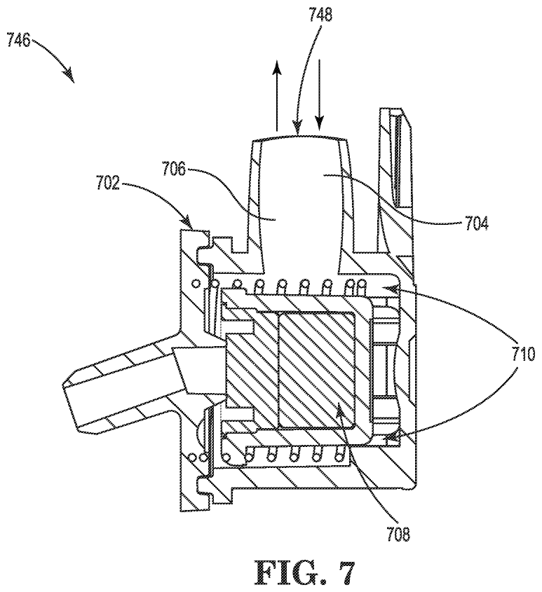

Although FIG. 1 is illustrated as including separate recirculation paths (e.g., recirculation inlet path 104 and recirculation outlet path 106), examples of the disclosure are not so limited. For example, the apparatus 100 can include a single recirculation path, as is further described in connection with FIGS. 7-10.

The valve body 102 can include a piston assembly 108. As used herein, the term “piston” refers to a part that fits and is movable within a cylinder. For example, the piston assembly 108 can be movable within the valve body 102 to open, close, or partially obstruct flow of material into the apparatus 100 from a print material supply cartridge, as is further described in connection with FIG. 3.

The apparatus 100 can include a recirculation cavity 110. As used herein, the term “cavity” refers to a hollow space within a physical structure. For example, the recirculation cavity 110 can be a hollow space inside apparatus 100. The recirculation cavity 110 can be a hollow space between the valve body 102 and the piston assembly 108.

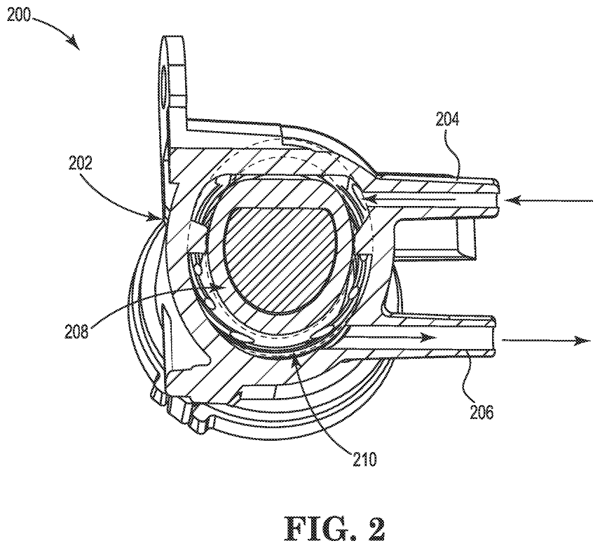

Print material can be circulated through the recirculation cavity 110. For example, print material can be provided to the recirculation cavity 110 via the recirculation inlet path 104, circulate through the recirculation cavity 110 in order to keep the interior of the apparatus 100 wet, and exit the recirculation cavity 110 via the recirculation outlet path 106, as is further described in connection with FIG. 2.

FIG. 2 is a top section view of an example of an apparatus 200 having recirculation cavities consistent with the disclosure. The apparatus 200 can include a valve body 202, a recirculation inlet path 204, a recirculation outlet path 206, a piston assembly 208, and a recirculation cavity 210.

As previously described in connection with FIG. 1, print material can be recirculated through the recirculation cavity 210. The print material can be recirculated through the recirculation cavity 210 via the recirculation inlet path 204 and the recirculation outlet path 206, as is further described herein.

The recirculation inlet path 204 can be connected to the recirculation cavity 210 such that the recirculation inlet path 204 can allow for fluidic transmission to the recirculation cavity 210. As used herein, the term “fluidic transmission” refers to the transportation of a fluid from a first position to a second position through a pathway. For example, the recirculation inlet path 204 can allow for transportation of print material into the recirculation cavity 210 through the recirculation inlet path 204.

The print material received by the recirculation cavity 210 from the recirculation inlet path 204 can travel through the recirculation cavity 210. The print material can exit the recirculation cavity 210 through the recirculation outlet path 206, as is further described herein.

The recirculation outlet path 206 can be connected to the recirculation cavity 210 such that the recirculation outlet path 206 can allow for fluidic transmission from the recirculation cavity 210. For example, the recirculation outlet path 206 can allow for transportation of print material out of the recirculation cavity 210 through the recirculation outlet path 206.

FIG. 3 is a section view of an example of a valve 317 having recirculation cavities consistent with the disclosure. The valve 317 can include a valve body 302, a recirculation inlet path 304, a recirculation outlet path 306, a piston assembly 308, a recirculation cavity 310, a supply inlet 312, a piston seal 314, and a biasing member 316.

As previously described in connection with FIG. 1, the valve 317 can include a valve body 302. The valve body 302 can include a piston assembly 308 located in the valve body 302, recirculation inlet path 304 and a recirculation outlet path 306, which can be connected with a recirculation cavity 310 (e.g., located between the valve body 302 and the piston assembly 308) to allow for recirculation of print material through the recirculation cavity 310 via the recirculation inlet path 304 and the recirculation outlet path 306.

The valve body 302 can include a supply inlet 312, As used herein, the term “supply inlet” refers to a passage along which something moves. For example, the supply inlet 312 can be a passage along which print material, provided by a print material supply cartridge (e.g., not illustrated in FIG. 3) moves into the valve body 302 when the valve 317 is in an open position to supply print material to an imaging device (e.g., not illustrated in FIG. 3).

As illustrated in FIG. 3, the valve 317 is in a closed position. The valve body 302 can include a piston seal 314. As used herein, the term “piston seal” refers to a surface of a piston which prevents fluidic transmission from a first position to a second position through a pathway. For example, while the valve 317 is in the closed position, the piston seal 314 can prevent fluidic transmission of print material from a print material supply cartridge via the supply inlet 312 into the valve 317. The piston seal 314 can be located adjacent to the supply inlet 312 to keep the supply inlet 312 closed (e.g., and the valve 317 in the normally closed position, as is further described herein).

The valve 317 can include a biasing member 316. As used herein, the term “biasing member” refers to a device to cause a structure to be oriented in a particular position. The biasing member 316 can be, for example, a spring. As used herein, the term “spring” refers to a mechanical device that stores energy. The biasing member 316 can be located around the piston assembly 308 such that the valve 317 is in a normally closed position. As used herein, the term “normally closed” refers to a valve which is normally in a position that prevents the flow of a fluid by being closed until acted upon by an external input. For example, the valve 317 can be normally closed as a result of the biasing member 316 causing the piston seal 314 to be adjacent to the supply inlet 312 to prevent fluidic transmission of print material between the recirculation cavity 310 and the supply inlet 312.

Although the biasing member 316 is described above as being a spring, examples of the disclosure are not so limited. For example, the biasing member 316 can be an elastic strap, among other types of biasing members.

As illustrated in FIG. 3, the valve body 302 can include a longitudinal axis 318, the piston assembly 308 can include a longitudinal axis 320, and the biasing member 316 can include a longitudinal axis 322. The longitudinal axis 320 of the piston assembly 308 can be coaxial with the longitudinal axis 318 of the valve body 302. The longitudinal axis 322 of the biasing member 316 can be coaxial with the longitudinal axis 318 of the valve body 302. Similarly, the longitudinal axis 320 of the piston assembly 308 can be coaxial with the longitudinal axis 322 of the biasing member 316. In other words, the longitudinal axes 318, 320, 322 of the valve body 302, piston assembly 308, and the biasing member 316, respectively, can be coaxial.

Print material can be circulated through the recirculation cavity 310 via the recirculation inlet path 304 and the recirculation outlet path 306 via a pump 324 when the valve 317 is in the normally closed position. As used herein, the term “pump” refers to a device that moves a fluid by mechanical action. For example, pump 324 can move print material to cause print material to be circulated through the recirculation cavity 310 via the recirculation inlet path 304 and the recirculation outlet path 306 when the valve 317 is in the normally closed position (e.g., supply inlet 312 is closed by the piston seal 314).

Although print material can be circulated through the recirculation cavity 310 via the pump 324 when the valve 317 is in the normally closed position, examples of the disclosure are not so limited. For example, print material can be periodically circulated through the recirculation cavity 310 via the pump 324, but at other times no print material is circulated through the recirculation cavity 310. For instance, print material may be circulated through the circulation cavity 310 when the valve 317 is to be wetted, but at other times no print material is circulated through the recirculation cavity 310. Such an example can allow for the pump 324 to only run periodically, which can save energy and preserve equipment for longer equipment lifecycles (e.g., resulting in lower equipment costs).

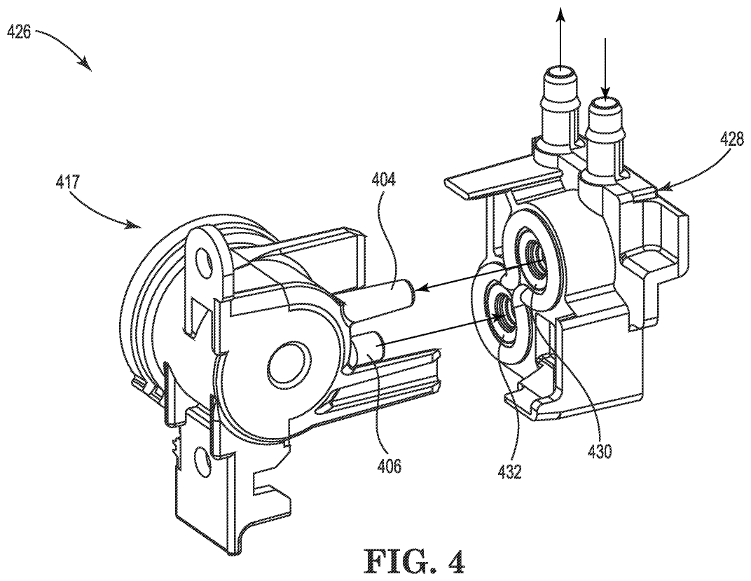

As is described above, print material can be circulated through the recirculation cavity 310 via the recirculation inlet path 304 and the recirculation outlet path 306 when the valve 317 is in the closed position. Although not illustrated in FIG. 3, a print material supply cartridge can supply print material to an imaging device via the valve 317 and a septum receptacle (e.g., as is further described in connection with FIGS. 4-6, 9, and 10) when the valve 317 is in the open position.

FIG. 4 is a perspective partially exploded view of an example of a system 426 including a valve 417 having recirculation cavities and a septum receptacle 428 consistent with the disclosure. The valve 417 can include a recirculation inlet path 404 and a recirculation outlet path 406. The septum receptacle 428 can include a first septum 430 and a second septum 432.

As previously described in connection with FIGS. 1-3, the valve 417 can include a valve body including a recirculation inlet path 404 and a recirculation outlet path 406, which can be connected with a recirculation cavity (e.g., not illustrated in FIG. 4) to allow for recirculation of print material through the recirculation cavity via the recirculation inlet path 404 and the recirculation outlet path 406.

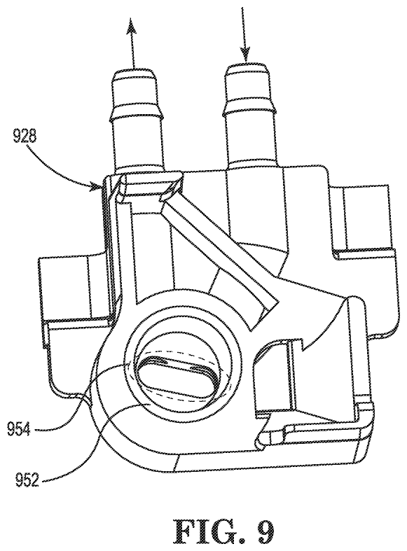

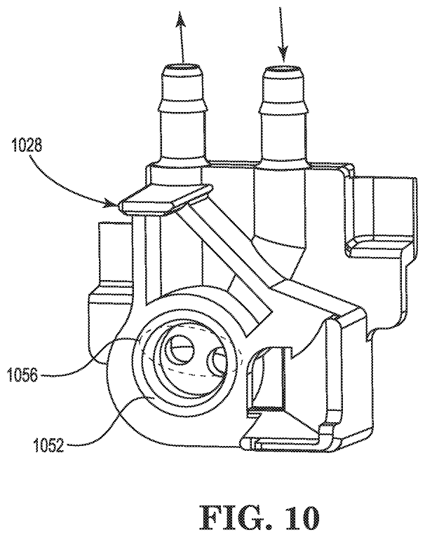

The system 426 can include a septum receptacle 428. As used herein, the term “septum receptacle” refers to a container having a septum. As used herein, the term “septum” refers to a dividing membrane between a first area and a second area. For example, the septum receptacle 428 can include a dividing membrane between an outer area of the septum receptacle 428 and inner circulation paths of the septum receptacle 428. As illustrated in the example of FIG. 4, the septum receptacle 428 can include two septa (e.g., first septum 430, second septum 432), as is further described herein. However, examples of the disclosure are not so limited. For example, the septum receptacle can include one septum, as is further described in connection with FIGS. 9 and 10.

The septum receptacle 428 can include a first septum 430. The first septum 430 can interface with the recirculation inlet path 404. For example, the recirculation inlet path 404 can be shaped such that the first septum 430 can receive the recirculation inlet path 404 and provide a fluid tight seal between the first septum 430 and the outer surface of the recirculation inlet path 404. In some examples, the first septum 430 can include a protrusion (e.g., a gasket) such that an interference fit is created between the first septum 430 and the outer surface of the recirculation inlet path 404 when they are interfaced to provide the fluid tight seal.

The septum receptacle 428 can include a second septum 432. The second septum 432 can interface with the recirculation outlet path 406. For example, the recirculation outlet path 406 can be shaped such that the second septum 432 can receive the recirculation outlet path 406 and provide a fluid tight seal between the second septum 432 and the outer surface of the recirculation outlet path 406. In some examples, the second septum 432 can include a protrusion (e.g., a gasket) such that an interference fit is created between the second septum 432 and the outer surface of the recirculation outlet path 406 when they are interfaced to provide the fluid tight seal.

Print material can be provided to the recirculation cavity by print material being provided to the recirculation inlet path 404 through the first septum 430, circulated through the recirculation cavity in order to keep the interior of the valve 417 wet, and exit the recirculation cavity via the recirculation outlet path 406 through the second septum 432.

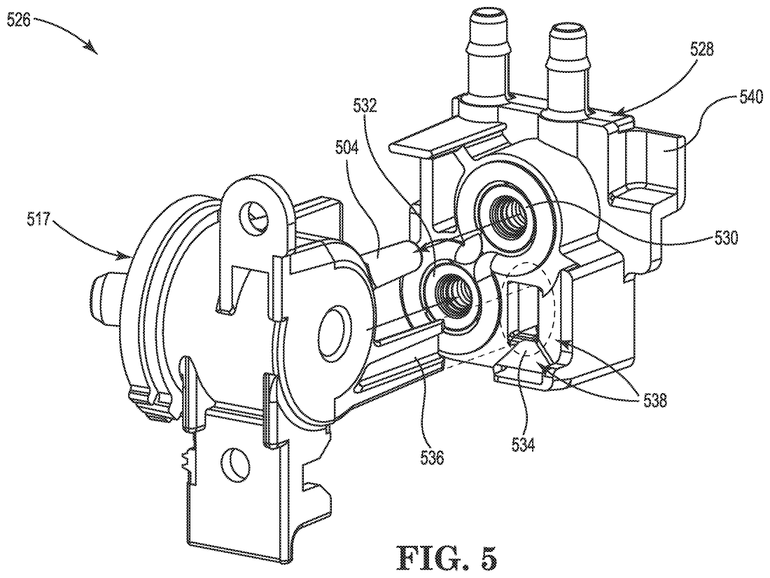

FIG. 5 is a perspective partially exploded view of an example of a system 526 including a valve 517 having recirculation cavities and a septum receptacle 528 consistent with the disclosure. The valve 517 can include a recirculation inlet path 504, a recirculation outlet path (e.g., not illustrated in FIG. 5), and an extension member 536. The septum receptacle 528 can include a first septum 530, a second septum 532, an aperture 534, angled directional surfaces 538, and flange 540.

As previously described in connection with FIGS. 1-4, the valve 517 can include a valve body including a recirculation inlet path 504 and a recirculation outlet path (e.g., not illustrated in FIG. 5), which can be connected with a recirculation cavity (e.g., not illustrated in FIG. 5) to allow for recirculation of print material through the recirculation cavity via the recirculation inlet path 504 and the recirculation outlet path. The recirculation inlet path 504 can interface with the first septum 530 and the recirculation outlet path can interface with the second septum 532.

The septum receptacle 528 can include an aperture 534. As used herein, the term “aperture” refers to an opening in a piece of material. For example, the aperture 534 can be an opening through the septum receptacle 528 and can include a particular shape.

The valve 517 can include an extension member 536. As used herein, the term “extension member” refers to a constituent part of a structure. For example, the extension member 536 can be a part of the valve 517 and can include a particular shape. The extension member 536 can include a length that is longer than a length of the recirculation inlet path 504 and/or the recirculation outlet path (e.g., not illustrated in FIG. 5).

The particular shape of the extension member 536 can correspond to the particular shape of the aperture 534 such that the aperture 534 can receive the extension member 536. For example, the aperture 534 can be rectangularly shaped and the extension member 536 can include a same rectangular shape such that the extension member 536 can be received by the aperture 534. Additionally, although the extension member 536 and the aperture 534 are described above as being complimentary rectangular shapes, examples of the disclosure are not so limited. For example, the extension member 536 and the aperture 534 can be complimentary circle shapes, oval shapes, triangular shapes, etc.

As described above, the extension member 536 can include a length that is longer than the length of the recirculation inlet path 504 and/or the recirculation outlet path. The extension member 536 having such a length can allow the extension member 536 to blind mate the first septum 530 with the recirculation inlet path 504. Similarly, the extension member 536 can blind mate the second septum 532 with the recirculation outlet path (e.g., not illustrated in FIG. 5). Such a dimension of the extension member 536 relative to the recirculation inlet path 504 and/or the recirculation outlet path can allow for the recirculation inlet path 504 and/or the recirculation outlet path to self-align when being interfaced together. Such a self-alignment feature can allow the recirculation inlet path 504 and/or the recirculation outlet path to align with the first septum 530 and second septum 532, respectively, to prevent damage to the recirculation inlet path 504 and/or the recirculation outlet path during interfacing, and/or prevent damage to the first septum 530 and/or second septum 532 during interfacing, which can prevent leaks of print material from the septum receptacle 528.

Although the valve 517 and the septum receptacle 528 are illustrated in FIG. 5 as having a single extension member 536 and aperture 534, respectively, examples of the disclosure are not so limited. For example, the valve 517 can include more than one extension member and the septum receptacle 528 can correspondingly include more than one aperture, which can be the same shape, differently shaped, and/or combinations thereof, which may help in providing self-alignment in multiple degrees of freedom during interfacing.

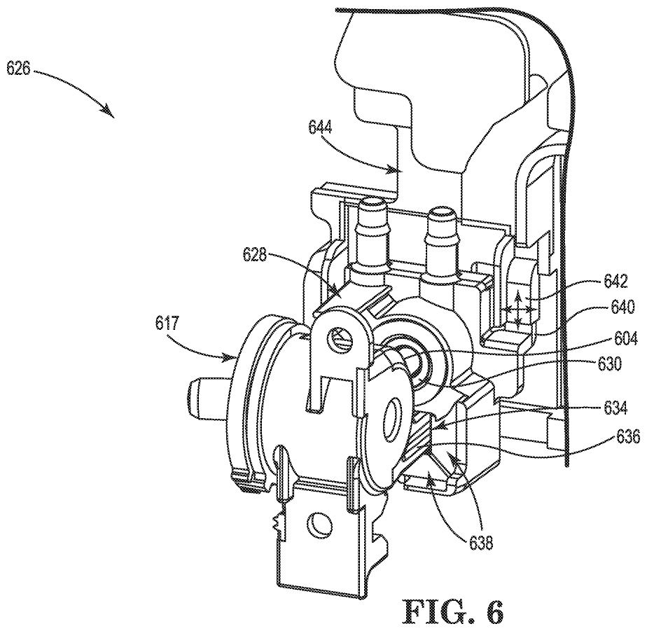

As illustrated in FIG. 5, the septum receptacle 528 can include angled directional surfaces 538 and flange 540. The angled directional surfaces 538 and flange 540 are further described in connection with FIG. 6.

FIG. 6 is a perspective view of an example of a system including a valve 617 having recirculation cavities, a septum receptacle 628, and a frame 644 consistent with the disclosure. The valve 617 can include a recirculation inlet path 604, a recirculation outlet path (e.g., not illustrated in FIG. 6), and an extension member 636. The septum receptacle 628 can include a first septum 630, a second septum (e.g., not illustrated in FIG. 6), an aperture 634, angled directional surfaces 638, and flange 640. The frame 644 can include a slot 642.

As previously described in connection with FIGS. 1-5, the valve 617 can include a valve body including a recirculation inlet path 604 and a recirculation outlet path (e.g., not illustrated in FIG. 6), which can be connected with a recirculation cavity (e.g., not illustrated in FIG. 6) to allow for recirculation of print material through the recirculation cavity via the recirculation inlet path 604 and the recirculation outlet path. The recirculation inlet path 604 can interface with the first septum 630 and the recirculation outlet path can interface with the second septum.

The extension member 636 can allow the recirculation inlet path 604 to blind mate with the first septum 630 and the recirculation outlet path to blind mate with the second septum. The extension member 636 can be received by the aperture 634 for self-alignment.

As illustrated in FIG. 6, the septum receptacle 628 can include angled directional surfaces 638. The angled directional surfaces 638 can be angled such that the extension member 636 contacting the angled directional surfaces 638 can direct the aperture 634 towards the extension member 636. For example, the angled directional surfaces 638 can be angled towards the aperture 634 such that if the extension member 636 contacts one or both of the angled directional surfaces 638, the septum receptacle 628 can move in two-degrees of freedom (e.g., as is further described below) in response to the force applied by the extension member 636 to guide the aperture 634 towards the extension member 636.

Although the septum receptacle 628 is illustrated in FIG. 6 as including two angled directional surfaces 638, examples of the disclosure are not so limited. For example, the septum receptacle 628 can include less than two angled directional surfaces 638 or more than two angled directional surfaces 638.

The septum receptacle 628 can include a flange 640. As used herein, the term “flange” refers to a plate of material projecting from an object. For example, the flange 640 can project from the septum receptacle 628. As illustrated in FIG. 6, the flange 640 can interface with a slot 642 of the frame 644. As used herein, the term “slot” refers to an opening. For example, the slot 642 can be an opening in the frame 644 to receive the flange 640. The slot 642 can allow the flange 640 (e.g., and consequently, the septum receptacle 628) two-degrees of freedom of movement during the interface of the extension member 636 with the aperture 634. For example, if the extension member 636 contacts the angled directional surfaces 638 during interfacing, the aperture 634 is guided towards the extension member 636 in response to the septum receptacle 628 being allowed the two-degrees of freedom of movement (e.g., vertically and/or horizontally, as oriented in FIG. 6).

FIG. 7 is a section view of an example of a valve 746 having recirculation cavities consistent with the disclosure. The valve 746 can include a valve body 702, a recirculation inlet path 704, a recirculation outlet path 706, a piston assembly 708, a recirculation cavity 710, and a recirculation path 748.

As previously described in connection with FIGS. 1-6, a valve 746 can include a valve body 702 having a recirculation inlet path 704 and a recirculation outlet path 706, As illustrated in FIG. 7, the valve 746 includes a recirculation path 748, The recirculation path 748 can be connected to the recirculation cavity 710 to allow for fluidic transmission to the recirculation cavity 710. For example, the recirculation inlet path 704 can allow for transportation of print material into the recirculation cavity 710 through the recirculation inlet path 704 where the print material can circulate through the recirculation cavity 710, and the recirculation outlet path 706 can allow for transportation of print material out of the recirculation cavity 710 through the recirculation outlet path 706, where the recirculation inlet path 704 and the recirculation outlet path 706 share the same recirculation path 748. As illustrated in FIG. 7, the recirculation path 748 can include counter-flow flow paths (e.g., the recirculation inlet path 704 and the recirculation outlet path 706), where the recirculation inlet path 704 and the recirculation outlet path 706 are not separated by a barrier. Accordingly, the example illustrated in FIG. 7 can provide for wetting of the valve 746.

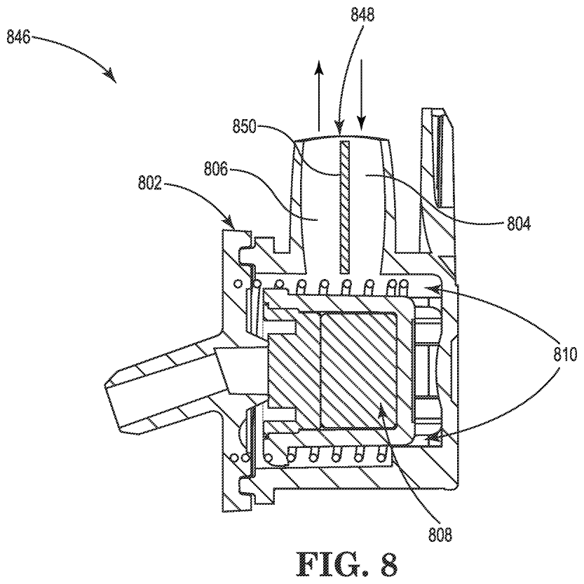

FIG. 8 is a section view of an example of a valve 846 having recirculation cavities consistent with the disclosure. The valve 846 can include a valve body 802, a recirculation inlet path 804, a recirculation outlet path 806, a piston assembly 808, a recirculation cavity 810, and a recirculation path 848.

As previously described in connection with FIGS. 1-6, a valve 846 can include a valve body 802 having a recirculation inlet path 804 and a recirculation outlet path 806. As illustrated in FIG. 8, the valve 846 includes a recirculation path 848 separated by a flow path barrier 850. The recirculation path 848 can be connected to the recirculation cavity 810 to allow for fluidic transmission to the recirculation cavity 810. For example, the recirculation inlet path 804 can allow for transportation of print material into the recirculation cavity 810 through the recirculation inlet path 804 where the print material can circulate through the recirculation cavity 810, and the recirculation outlet path 806 can allow for transportation of print material out of the recirculation cavity 810 through the recirculation outlet path 806, where the recirculation inlet path 804 and the recirculation outlet path 806 are separated by the flow path barrier 850. As illustrated in FIG. 8, the recirculation path 848 can include counter-flow flow paths (e.g., the recirculation inlet path 804 and the recirculation outlet path 806), where the recirculation inlet path 804 and the recirculation outlet path 806 are separated by the flow path barrier 850. Accordingly, the example illustrated in FIG. 8 can provide for wetting of the valve 846 and recirculation of print material in the valve 846.

FIG. 9 is a perspective view of an example of a septum receptacle 928 consistent with the disclosure. The septum receptacle 928 can include a septum 952 and a non-directional flow port 954.

As illustrated in FIG. 9, the septum receptacle 928 can include a septum 952. The septum 952 can be shaped such that the septum 952 can receive the recirculation path (e.g., recirculation path 748, 848, previously described in connection with FIGS. 7 and 8). The septum 952 can include a protrusion (e.g., a gasket) such that an interference fit is created between the septum 952 and the outer surface of the recirculation path when they are interfaced to provide a fluid tight seal.

The septum receptacle 928 can include a non-directional flow port 954, The non-directional flow port 954 can provide print material to the recirculation path of the valve when the recirculation path of the valve is interfaced with the septum 952, Accordingly, print material can be provided to the recirculation cavity of the valve by print material being provided to the recirculation path through the non-directional flow port 954, circulated through the recirculation cavity in order to keep the interior of the valve wet, and exit the recirculation cavity via the recirculation path through the non-directional flow port 954.

FIG. 10 is a perspective view of an example of a septum receptacle 1028 consistent with the disclosure. The septum receptacle 1028 can include a septum 1052 and a directional flow port 1056.

As illustrated in FIG. 10, the septum receptacle 1028 can include a septum 1052. The septum 1052 can be shaped such that the septum 1052 can receive the recirculation path (e.g., recirculation path 748, 848, previously described in connection with FIGS. 7 and 8). The septum 1052 can include a protrusion (e.g., a gasket) such that an interference fit is created between the septum 1052 and the outer surface of the recirculation path when they are interfaced to provide a fluid tight sea.

The septum receptacle 1028 can include a directional flow port 1056. The directional flow port 1056 can provide print material to the recirculation path of the valve when the recirculation path of the valve is interfaced with the septum 1052. Accordingly, print material can be provided to the recirculation cavity of the valve by print material being provided to the recirculation inlet path of the recirculation path through the directional flow port 1056, circulated through the recirculation cavity in order to keep the interior of the valve wet, and exit the recirculation cavity via the recirculation outlet path of the recirculation path through the directional flow port 1056.

An apparatus having recirculation cavities, according to the disclosure, can allow for a valve to receive and recirculate print material in the valve while the valve is in a closed position. Recirculating print material in the valve can prevent print material from drying inside the valve, which can prevent dried print material from inhibiting valve function, and/or causing damage to the valve and/or the imaging device.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” can refer to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 202 in FIG. 2. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples and data provide a description of the method and applications, and use of the system and method of the disclosure. Since many examples can be made without departing from the spirit and scope of the system and method of the disclosure, this specification merely sets forth some of the many possible example configurations and implementations.

What is claimed is:

1. An apparatus, comprising:
a valve body including a recirculation inlet path and a recirculation outlet path;
a piston assembly located in the valve body; and
a recirculation cavity between the valve body and the piston assembly;
wherein print material is to be circulated through the recirculation cavity via the recirculation inlet path and the recirculation outlet path.

2. The apparatus of claim 1, wherein the recirculation inlet path is arranged to allow fluidic transmission to the recirculation cavity.

3. The apparatus of claim 1, wherein the recirculation outlet path is arranged to allow fluidic transmission from the recirculation cavity.

4. The apparatus of claim 1, wherein:
the valve body includes a longitudinal axis; and
the piston assembly includes a longitudinal axis that is coaxial with the longitudinal axis of the valve body.

5. The apparatus of claim 1, wherein:
the valve body includes a supply inlet;
the piston assembly includes a piston seal; and
the piston seal is located adjacent to the supply inlet to keep the supply inlet closed.

6. The apparatus of claim 5, wherein the print material is to be circulated through the recirculation cavity when the supply inlet is closed by the piston seal.

7. A valve, comprising:
a valve body including a recirculation inlet path and a recirculation outlet path;
a piston assembly located in the valve body and including a piston seal;
a biasing member located around the piston assembly such that the valve is in a normally closed position; and
a recirculation cavity between the valve body and the piston assembly;
wherein print material is to be circulated through the recirculation cavity via the recirculation inlet path and the recirculation outlet path via a pump when the valve is in the normally closed position.

8. The valve of claim 7, wherein the valve body includes a supply inlet.

9. The valve of claim 8, wherein the biasing member causes the piston seal to be located adjacent to the supply inlet when the valve is in the normally closed position to prevent fluidic transmission between the recirculation cavity and the supply inlet.

10. The valve of claim 7, wherein:
the valve body includes a longitudinal axis; and
the biasing member includes a longitudinal axis that s coaxial h the longitudinal axis of the valve body.

11. A system, comprising:
a valve including:
a valve body including a recirculation inlet path and a recirculation outlet path;
a piston assembly located in the valve body and including a piston seal;
a biasing member located around the piston assembly such that the biasing member is to cause the valve to be in a normally closed position; and
a recirculation cavity between the valve body and the piston assembly; and
a septum receptacle including:
a first septum to interface with the recirculation inlet path; and
a second septum to interface with the recirculation outlet path;
wherein the septum receptacle is to direct print material to be circulated through the recirculation cavity of the valve via the recirculation inlet path and the recirculation outlet path.

12. The system of claim 11, wherein:
the septum receptacle includes an aperture having a particular shape; and
the valve body includes an extension member having a shape corresponding to the particular shape of the aperture.

13. The system of claim 12, wherein the extension member of the valve body is to interface with the aperture of the septum receptacle to blind mate the first septum with the recirculation inlet path and the second septum with the recirculation outlet path.

14. The system of claim 13, wherein the septum receptacle includes an angled directional surface such that the angled directional surface is to guide the extension member of the valve body towards the aperture.

15. The system of claim 13, wherein the septum receptacle includes a flange to interface with slot of a frame, wherein the slot is to allow the septum receptacle at least one-degree of freedom of movement during the interface of the extension member of the valve body with the aperture of the septum receptacle.
